(19) United States
(12) Patent Application Publication
(10) Pub. No.: US 2017/0142223 A1
(43) Pub. Date: May 18, 2017

(54) SOFTWARE-DEFINED NETWORKING MULTI-ORCHESTRATOR SYSTEM

(71) Applicant: ELECTRONICS AND TELECOMMUNICATIONS RESEARCH INSTITUTE, Daejeon (KR)

(72) Inventors: Ji-Hyun LEE, Daejeon (KR); Seung-Ik LEE, Daejeon (KR); Myung-Ki SHIN, Seoul (KR)

(73) Assignee: ELECTRONICS AND TELECOMMUNICATIONS RESEARCH INSTITUTE, Daejeon (KR)

(21) Appl. No.: 15/251,217

(22) Filed: Aug. 30, 2016

(30) Foreign Application Priority Data
Nov. 16, 2015 (KR) 10-2015-0160245

(51) Int. Cl. H04L 29/08; H04L 12/915; H04L 12/715

(52) U.S. Cl. CPC H04L 67/32; H04L 69/321; H04L 45/04; H04L 47/785

(57) ABSTRACT

Disclosed is an orchestrator, which efficiently manages various applications and management services that are running in a SDN environment. The SDN multi-orchestrator system includes an application layer orchestrator for orchestrating multiple applications provided by a SDN application layer that provides the applications by utilizing network resources with programmatic manners, a control layer orchestrator for orchestrating resource allocation between resource requirements from the applications and for controlling data packet transmission using virtual and physical network resources in a resource layer and a management layer orchestrator for managing multiple management services provided by management layer to coordinate the application layer and the control layer. Accordingly, the multi-orchestrator structure may provide management and orchestration functions in consideration of the characteristics of respective layers, thus providing a more rapid and efficient orchestration function via specialization and automation.

### CROSS REFERENCE TO RELATED APPLICATION

This application claims the benefit of Korean Patent Application No. 10-2015-0160245, filed Nov. 16, 2015, which is hereby incorporated by reference in its entirety into this application.

### BACKGROUND OF THE INVENTION

1. Technical Field

The present invention relates to an orchestrator, which efficiently manages various applications or management services that are running in a Software-Defined Networking (SDN) environment.

2. Description of the Related Art

In a Software-Defined Networking (SDN) environment, existing network structures are divided into a resource layer, a control layer, an application layer, and a multi-layer management layer, and are capable of controlling the operation of switches corresponding to the resource layer via software. That is, this means that external applications may control the SDN functions via software.

In a current SDN structure, an orchestrator is present in a control layer, and provides functions of receiving resource requirements from an application layer and allocating and controlling the resources of a resource layer, as well as an automated management function between the layers. Such an orchestrator in the control layer performs a function of orchestrating the requirements between individual layers, but does not provide functions, such as orchestration and management, internally required in each layer.

However, each of the application layer and the management layer requires an orchestrator function specialized for each layer, which administers various applications or management services present in each layer and which takes into account the characteristics between the applications or the management services.

### SUMMARY OF THE INVENTION

Accordingly, the present invention has been made keeping in mind the above problems occurring in the prior art, and an object of the present invention is to provide a SDN multi-orchestrator system, which provides respective orchestrators specialized for an application layer, a control layer and a management layer in order to provide an efficient management function for each layer in SDN environments.

In detail, the present invention is intended to propose an orchestrator specialized for an application layer, which performs orchestration such that, when various applications in the application layer have requirements and make requests for the same resource and the same function, those applications are classified into a similar group, and tasks suitable for respective policies may be performed.

Further, the present invention is intended to propose an orchestrator specialized for various management services performed in a management layer.

In accordance with an aspect of the present invention to accomplish the above objects, there is provided a Software-Defined Networking (SDN) multi-orchestrator system, including an application layer orchestrator for orchestrating multiple applications provided by a SDN application layer that provides the applications by utilizing network resources with programmatic manners; a control layer orchestrator for orchestrating resource allocation between resource requirements from the applications and for controlling data packet transmission using virtual and physical network resources in a resource layer; and a management layer orchestrator for managing multiple management services provided by a management layer to coordinate the application layer and the control layer.

The application layer or management layer orchestrator may compare resource requirements of applications or management services and then group the applications or management services.

The application layer or management layer orchestrator may schedule ordering of execution of the grouped applications or management services based on policies.

The application layer or management layer orchestrator may manage the multiple applications or management services by reflecting results of execution.

The application layer orchestrator may categorize the applications according to at least one of identification information, resource requirement information, routing requirement information, service-related information, execution ordering information, and policy information to be applied to the applications, and then make grouping the applications and the management layer orchestrator also has categorizing and grouping functionalities according to the characteristics of management services.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram of a typical SDN environment;

FIG. 2 is a conceptual diagram of a network environment to which a SDN multi- orchestrator system according to an embodiment of the present invention is applied;

FIG. 3 is a flowchart showing the operation of respective layer orchestrators in the SDN multi-orchestrator system according to an embodiment of the present invention; and

FIG. 4 is a configuration diagram showing a control layer orchestrator among SDN multi-orchestrators according to an embodiment of the present invention.

### DESCRIPTION OF THE PREFERRED EMBODIMENTS

The following description merely illustrates the principle of the present invention. Therefore, although not clearly described in the present specification or shown in the drawings, those skilled in the art may practice the principle of the present invention and may revise various devices included in the concept and scope of the present invention. Further, in principle, all conditional terms and embodiments listed in the present specification are clearly intended only for understanding of the concept of the present invention, and should be understood not to be limited by embodiments and states especially listed in this way.

The above-described objects, features and advantages will be more clearly understood from the following detailed description taken in conjunction with the accompanying drawings. Accordingly, those skilled in art to which the present invention pertains may easily practice the technical spirit of the present invention.

Further, repeated descriptions and descriptions of known functions and configurations which have been deemed to make the gist of the present invention unnecessarily obscure will be omitted below. Hereinafter, preferred embodiments of the present invention will be described in detail with reference to the attached drawings.

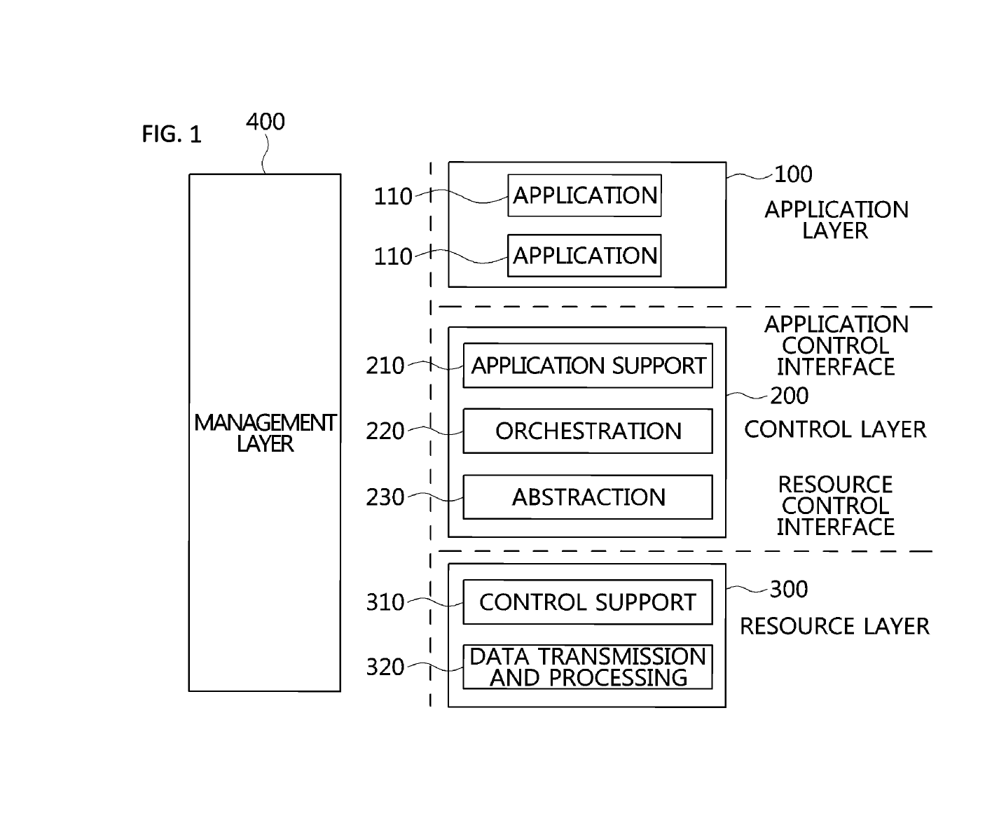

FIG. 1 is a conceptual diagram of a typical SDN environment.

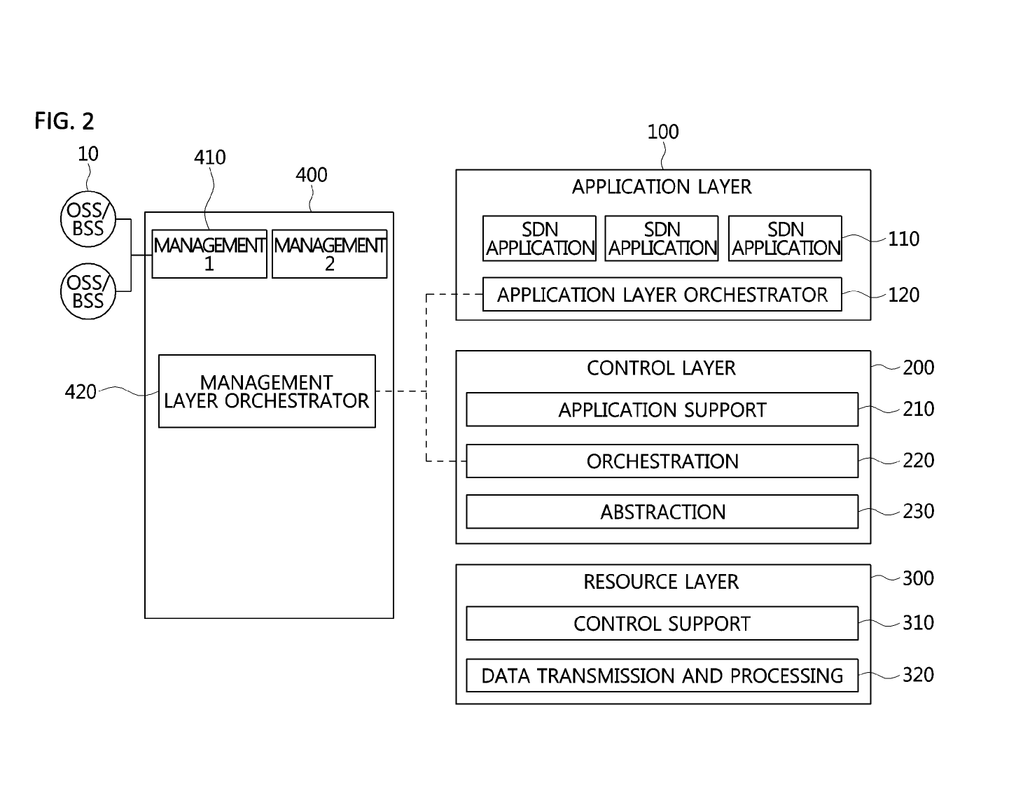

Further, FIG. 2 is a diagram conceptually illustrating a network environment to which a SDN multi-orchestrator system according to an embodiment of the present invention is applied.

Referring to FIGS. 1 and 2, in the SDN environment, existing network structures may be classified into a resource layer 300, a control layer 200, an application layer 100, and a multi-layer management layer 400, and may control the operations of switches corresponding to the resource layer via software.

That is, the SDN environment means that external applications 110 are capable of controlling a SDN function via software.

Such a SDN application 110 denotes a software program for performing tasks in the SDN environment, and may be replaced or extended depending on the function implemented as firmware through the hardware device of a conventional network.

The types of SDN applications 110 include not only security-related applications, such as network virtualization, network monitoring, Intrusion Detection Systems (IDS), and firewalls, but also routing applications, traffic load-balancing applications, and Quality of Service (QoS) applications.

In relation to this, in the conventional SDN environment shown in FIG. 1, an orchestrator 220 is present only in the control layer 200 and is configured to provide a function such as the reception of requirements for network resources from the application layer 100, a function such as the allocation and control of resources from the resource layer 300, and an automated management function between the layers. However, the orchestrator 220 does not provide orchestration and management functions internally required in each layer.

Therefore, the SDN environment according to the present invention is intended to provide a management function specialized for each layer by applying multiple orchestrators.

Referring to FIG. 2, the SDN environment of FIG. 2 indicates a structure in which orchestrators 120 and 420 for an application layer and a management layer, together with a control layer orchestrator 220, are present.

In the present embodiment, the application layer orchestrator 120 orchestrates multiple applications provided by the SDN application layer 100 which provides the applications by utilizing network resources with programmatic manners.

As described above, the control layer orchestrator 220 orchestrates resource allocation between resource requirements from the applications and for controlling data packet transmission using virtual and physical network resources in a resource layer.

In the present embodiment, the management layer orchestrator 420 manages multiple management services, provided by the management layer 400 to coordinate the application layer and the control layer.

In the present embodiment, the SDN management services include fault management, configuration management, accounting management, performance management, security management, etc.

Therefore, the application layer orchestrator 120 and the management layer orchestrator 420 according to the present embodiment may not only provide management of the lifecycle of a single application or management service in each layer, but may also provide a single new application or management service by classifying applications or management services in consideration of the characteristics thereof, scheduling the applications or management services based on the corresponding policies, and then combining multiple applications or management services into an integrated application or management service.

That is, each of the orchestrators 120 and 420 of the application layer 100 and the management layer 400 provides an orchestration function specialized for the corresponding layer, and the orchestrator 220 of the control layer 200 provides an overall orchestration and collaboration function in a SDN environment, such as receiving requirements and allocating resources between individual layers. For this, a function of transmitting and receiving related data between multiple orchestrators must be provided.

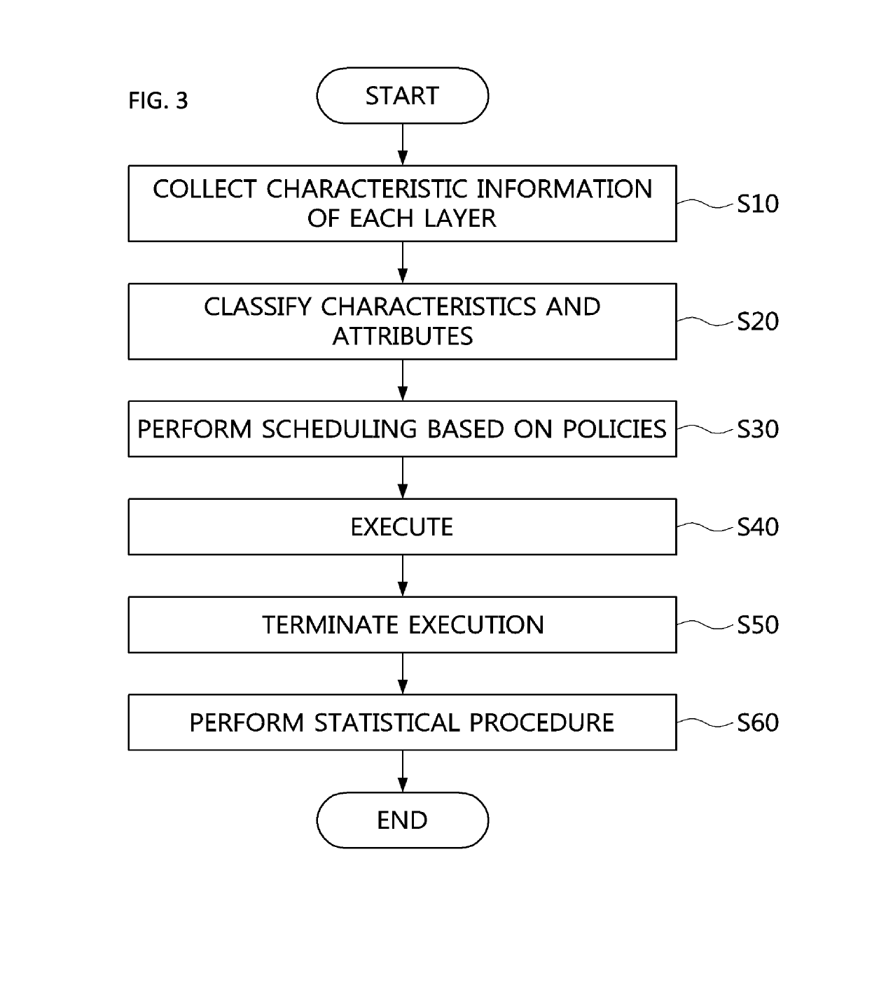

Hereinafter, the detailed operation of the application layer orchestrator 120 or the management layer orchestrator 420 according to the present embodiment will be described with reference to FIG. 3.

In the present embodiment, each of the orchestrators 120 and 420 respectively present in the application layer and the management layer basically provides functions, such as management and orchestration between the applications of the application layer or between the management services of the management layer.

For this, each orchestrator collects information about applications or management services specialized for the corresponding layer at step S10.

The information collected in the present embodiment is composed of basic information about each application program (id and name), requirements for necessary network resources (network capability, network performance (throughput), network resource capacity (cpu, memory, disk, . . . ), specific routing or path information, etc.), service description of each network service that is used, the ordering of execution of network service operations, policies to be applied to the corresponding application, etc.

Based on the collected information, respective characteristics and attributes are analyzed, and applications or management services that request similar functions are classified into the same group at step S20. That is, the application layer orchestrator 120 categorizes according to at least one of identification information, resource requirement information, routing requirement information, service related information, execution ordering information, and policy information to be applied to the applications, and then makes grouping the applications and the management layer orchestrator 420 also has categorizing and grouping functionalities according to the characteristics of management services.

By means of this classification, the effect of obtaining fast execution and responses may be predicted by orchestrating the execution of repetitive operations of respective services and reducing the number of redundant tasks having the same function. In addition, classification functions include not only a function of grouping similar functions, but also a function of clustering multiple applications or management services to provide a single new application or management service.

For the classified applications or management services, the orchestrator schedules applications or management services in which related policies are reflected when there are the related policies at step S30.

Generally, as the scheduling technique used in the present embodiment, various scheduling techniques may be applied in response to a request from an application provider or a management institution that performs a management service.

The applications or management services subjected to the scheduling procedure are executed in the corresponding order at step S40 and undergo a termination procedure S50, and the results of executing the services are subjected to a statistical procedure S60 in the orchestrator and are reflected in the execution of a subsequent function, thus enabling a more efficient orchestration function to be provided.

Further, in the present embodiment, the orchestrators 120 and 420 of the application layer and the management layer provide orchestration functions specialized for respective layers, and the orchestrator of the control layer provides an overall orchestration and collaboration function in a SDN environment, such as functions of receiving requirements and allocating resources between individual layers. Therefore, among the multiple orchestrators according to the present invention, a function of transmitting and receiving related data must be provided.

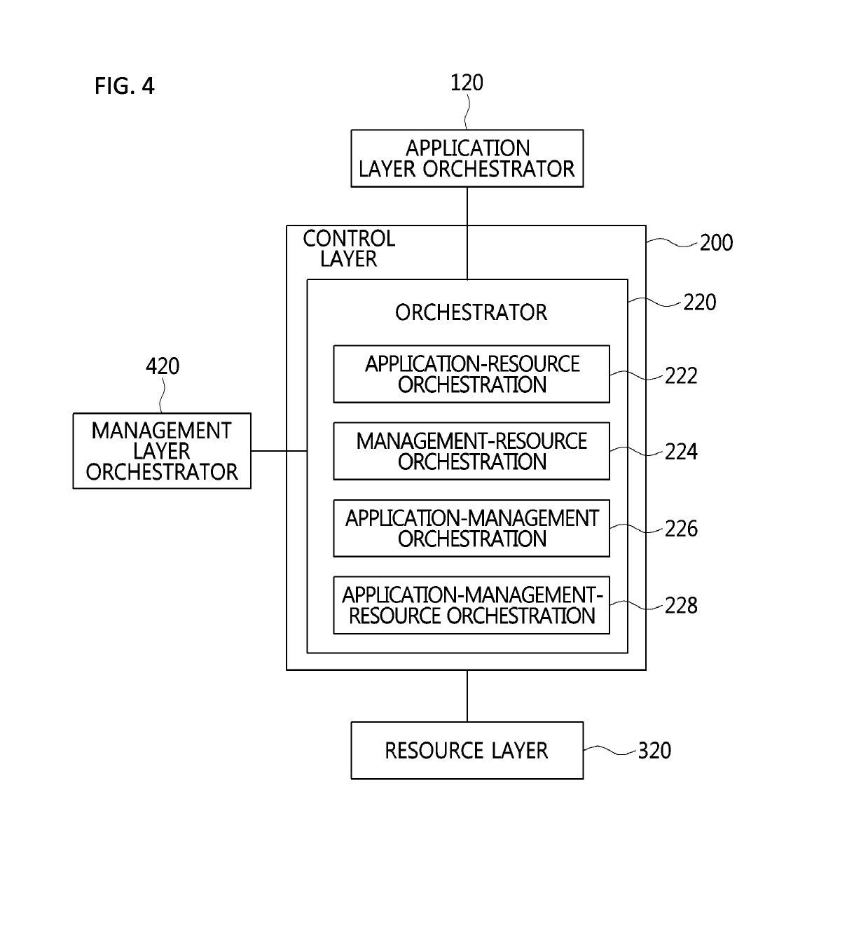

Below, the control layer orchestrator 220 of the SDN multi-orchestrator system according to the present invention will be described in detail with reference to FIG. 4.

In the present embodiment, the control layer orchestrator 220 performs a function of receiving requirements transferred from the orchestrator 120 of the application layer and the orchestrator 420 of the management layer, and a function of mapping and orchestrating the requests between the layers. For this, the control layer orchestrator 220 provides a mapping or orchestration function 222 between application and infrastructure (resources), a mapping or orchestration function 224 between management service and infrastructure, a mapping or orchestration function 226 between application and management service, and an integrated mapping or orchestration function 228 between application, management service, and infrastructure. This prevents a specific application or a specific management service from exclusively possessing resources, enables resources to be efficiently distributed among respective layers, and reduces processing time.

In accordance with the present invention, a multi-orchestrator structure may provide management and orchestration functions in consideration of the characteristics of respective layers, thus providing a more rapid and efficient management function via specialization and automation.

More specifically, an application layer may manage the lifecycle of applications in consideration of the characteristics of respective applications, and may not only reflect requirements and policies of various applications, but also prevent the execution of repetitive functions in advance and provide a fast response effect when new applications are developed using various network applications.

Furthermore, the present invention provides new applications or management services by utilizing various network applications or management services that have been conventionally developed and used, thus reducing development expenses and creating new business models.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Therefore, the embodiments disclosed in the present invention and the attached drawings are merely intended to describe the technical spirit of the present invention and are not intended to limit the meanings thereof or the scope of the present invention, and the scope of the technical spirit of the present invention is not limited by the embodiments and the attached drawings. Therefore, the technical scope of the present invention should be defined by the accompanying claims, and all technical spirit in the claims and equivalents thereof should be construed as being included in the scope of the present invention.

1. A Software-Defined Networking (SDN) multi-orchestrator system, comprising:
an application layer orchestrator for orchestrating multiple applications provided by a SDN application layer that provides the applications by utilizing network resources with programmatic manners; and
a control layer orchestrator for orchestrating network resources for requirements from the SDN application layer and for controlling data transport using virtual and physical network resources in a resource layer.

2. The SDN multi-orchestrator system of claim 1, wherein the application layer orchestrator categorizes the applications according to at least one of identification information, resource requirement information, routing requirement information, service-related information, execution ordering information, and policy information to be applied to the applications, and then makes grouping the applications.

3. The SDN multi-orchestrator system of claim 2, wherein the application layer orchestrator schedules ordering of execution of the grouped the applications based on policies related to the applications.

4. The SDN multi-orchestrator system of claim 3, wherein the application layer orchestrator manages the multiple applications within the SDN application layer.

5. The SDN multi-orchestrator system of claim 3, wherein the application layer orchestrator combines the multiple applications into an integrated application.

6. A Software-Defined Networking (SDN) multi-orchestrator system, comprising:
an application layer orchestrator for orchestrating multiple applications provided by a SDN application layer that provides the applications by utilizing network resources with programmatic manners;
a control layer orchestrator for orchestrating network resources for requirements from the SDN application layer and for controlling data transport using virtual and physical network resources in a resource layer; and
a management layer orchestrator for managing the SDN application layer and the control layer.

7. The SDN multi-orchestrator system of claim 6, wherein the application layer orchestrator categorizes the applications according to at least one of identification information, resource requirement information, routing requirement information, service-related information, execution ordering information, and policy information to be applied to the applications, and then makes grouping the applications, and the management layer orchestrator has categorizing and grouping functionalities according to the characteristics of management services.

8. The SDN multi-orchestrator system of claim 7, wherein the application layer or management layer orchestrator schedules ordering of execution of the grouped applications or management services based on policies.

9. The SDN multi-orchestrator system of claim 8, wherein the application layer orchestrator manages the multiple applications within the SDN application layer.

10. The SDN multi-orchestrator system of claim 8, wherein the application layer orchestrator combines the multiple applications into an integrated application or management service.

11. The SDN multi-orchestrator system of claim 6, wherein the control layer orchestrator provides coordination of requests from the SDN application layer, and controls the network resources.
